(19) United States
(12) Patent Application Publication
(10) Pub. No.: US 2021/0262668 A1
(43) Pub. Date: Aug. 26, 2021

(54) ELECTRIC COMPOSITE HEAT OVEN WITH SIGHT WINDOW FOR TRANSPARENT PLANAR HEATING ELEMENT

(71) Applicant: Ik-No LEE, Seoul (KR)

(72) Inventor: Ik-No LEE, Seoul (KR)

(21) Appl. No.: 17/260,725

(22) PCT Filed: Jul. 16, 2019
(86) PCT No.: PCT/KR2019/008768

§ 371 Date: Jan. 15, 2021

(30) Foreign Application Priority Data
Jul. 25, 2018 (KR) 10-2018-0086677

(51) Int. Cl. F24C 7/06; F24C 15/04; F24C 7/08

(52) U.S. Cl. CPC F24C 7/067; F24C 7/085; F24C 15/04

(57) ABSTRACT

An electric composite heat oven provided with a sight window of a transparent planar heating element is provided. Since the electric composite heat oven has a structure in which a heater heating element is installed, being lower than the upper end of a cooking container, on the front and rear sidewalls of a cooking chamber of an enclosure and a transparent planar heating element is installed over an opening of the cooking chamber of the enclosure, radiant heat may actively control various disturbances that occur during cooking depending on a place where the oven is installed and a change in temperature, whereby there is an effect of providing the optimum heat power depending on a cooking material and also shortening cooking time.

### TECHNICAL FIELD

The present invention relates to an electric composite heat oven provided with a sight window of a transparent planar heating element and, more particularly, to an electric composite heat oven provided with a sight window of a transparent planar heating element, the electric composite heat oven being capable of actively controlling disturbances by controlling intensity of convective heat and radiant heat by means of the transparent door planar heating element and heater heating elements controlling the convective heat.

### BACKGROUND

In general, an oven for cooking is mostly equipped with a heater (i.e., heater that generates convective heat) inside an enclosure thereof, and radiant heat is generated through preheating by the inherent characteristics (i.e., emissivity, heat capacity, and radiant area depending on a material of the enclosure) of an oven's enclosure.

Meanwhile, as for a sight window of an oven, a cooking material should be radiated with the heat generated from inside the oven, but at this time, when a sudden change occurs in the amount of the radiant heat emitting from the oven to the outside, the sight window is unable to respond to the change accordingly.

That is, a ratio of convective heat and radiant heat has a great importance in cooking. In general, a cooking material should be provided with different thermal power (i.e., each different heat amount of convective heat and radiant heat) according to the type, size, and quantity of the cooking material. In addition, accordingly, caramelization reaction and Maillard reaction on the surface of the cooking material, moisture and fat content in the core of the cooking material, etc. are also changed.

In the past, radiant heat was generated by preheating of the oven enclosure with a convection heater, but recently, some attempts have been made to generate heat by a radiation heater, and a convection heater installed in the oven enclosure.

However, these attempts are insufficient to control various disturbances occurred during cooking. In particular, it is almost impossible to control the disturbances occurred from the outside.

In addition, most of the sight windows of ovens are equipped with glass. Glass has an emissivity of about 0.9, and is a material that absorbs and emits radiant heat very well.

When such glass is exposed to the outside, radiant heat generated from the inside of an oven is radiated to the inside and outside of the oven according to heat gradient. In particular, in the heat which is radiated to the outside, a radiant amount of the radiant heat varies depending on conditions of an oven installed place.

That is, Stefan-Boltzmann's law of radiant energy is defined as: E=σεAT⁴ (where, σ: Stefan-Boltzmann constant, ε: emissivity, A: heat transfer area, T: absolute temperature)

Stefan-Boltzmann's law of radiant energy described above may more clearly explain disturbances due to a place where the oven is installed.

Most places where an oven is installed have a considerably larger area than that of a sight window of the oven, and the emissivity (i.e., absorption rate) varies depending on materials in the oven installed place. However, most of the places are equipped with the material with a relatively high emissivity (i.e., absorption rate).

For example, in a case in which an oven is installed in a place where temperature of external heat absorbing surface (i.e., wall, ceiling, etc.) is 20 degrees and an area of the place is 100 times larger than that of a sight window of the oven, when the temperature of the external heat absorbing surface is decreased to 10 degrees due to a change in temperature, results of cooking may be undesirable.

In addition, although the absolute temperature slightly decreased from 293 degrees Celsius to 283 degrees Celsius, the total outflow amount of radiant energy increases more than 10 times depending on the increased heat energy gradient.

Accordingly, glass of the sight window cools down and the heat gradient between the glass and the cooking material is reduced, so that the radiant heat applied to the cooking material is also reduced.

In addition, since the radiant heat outflow from the sight window of the oven fluctuates even with a location change in the oven installed place, it is necessary to control the temperature of the sight window for optimal cooking.

Therefore, in order to control the oven accurately, an active temperature control of the sight window serves as an important factor.

### SUMMARY

### Technical Problem

The present invention is proposed to solve the problems in consideration of all the existing problems, and an objective of the present invention is to provide an electric composite heat oven provided with a sight window of a transparent planar heating element, wherein cooking time is shortened by actively controlling temperature of the sight window, optimum thermal power is provided depending on a cooking material, and a cleaning problem may be easily solved by employing a detachable cooking container.

### Technical Solution

According to an exemplary embodiment of the present invention for solving the above technical problems, an electric composite heat oven provided with a sight window of a transparent planar heating element includes: an enclosure having a cooking chamber; a door for opening or closing an opening of the enclosure; a cooking-material fixing means for fixing cooking material inside the enclosure; heater heating elements installed on inner sidewalls of the enclosure to generate convective heat; and the transparent planar heating element installed in the door to generate radiant heat.

In another exemplary embodiment of the present invention, the transparent planar heating element may be combined in an inner space of the door, and an exterior of the door may be supported by a door support means to open or close an upper opening of the cooking chamber, the door support means being pivotably hinged on a side of an upper end of the enclosure.

In another exemplary embodiment of the present invention, the cooking-material fixing means may be configured to include a cooking container formed lower than a height of the cooking chamber so that heat generated by the heater heating elements passes through an upper opening of the cooking container; and a grill mounted on the cooking container.

In another exemplary embodiment of the present invention, the cooking container may be configured to include: bent pieces protruding inward by cutting from a pair of left and right handle holes so that the grill is mounted at a predetermined height of left and right sidewalls of the cooking container; and a plurality of heat circulation holes arranged at regular intervals in each lower part of front and rear sidewalls of the cooking container.

In another exemplary embodiment of the present invention, the heater heating elements may be respectively installed to be horizontal with respect to a front sidewall and a rear sidewall of the cooking chamber at a predetermined height lower than a height of an upper end of the cooking container.

### Advantageous Effects

In the electric composite heat oven provided with the sight window of the transparent planar heating element of the present invention, since the oven has a structure in which a pair of heater heating elements is installed, being lower than an upper end of the cooking container, on the front and rear sidewalls of the cooking chamber of the enclosure and the transparent planar heating element is installed over the opening of the cooking chamber of the enclosure, radiant heat may actively control various disturbances that occur during cooking depending on the oven installed place and the a change in temperature, whereby there is an effect of providing the optimum heat power depending on a cooking material and also shortening cooking time.

In addition, in the electric composite heat oven provided with the sight window of the transparent planar heating element of the present invention, since the electric composite heat oven has a structure in which the cooking container is able to be moved in and out of the cooking chamber through an open upper opening of the cooking chamber, meat juice, food debris, and etc. flowing down from the cooking material during cooking is able to be received, whereby there is an advantage in that contamination of the interior of the enclosure may be minimized and the cooking container may be cleaned by being separated from the enclosure.

### BRIEF DESCRIPTION OF THE DRAWINGS

FIG. 1 is a perspective view showing a closed state of a door of an electric composite heat oven according to the present invention.

FIG. 2 is a perspective view showing an opened state of the door of the electric composite heat oven according to the present invention.

FIG. 3 is a perspective view showing a cooking container used in the electric composite heat oven according to the present invention.

FIG. 4 is a longitudinal cross-sectional view showing the electric composite heat oven according to the present invention.

### DESCRIPTION OF THE REFERENCE NUMERALS IN THE DRAWINGS

10: enclosure 11: cooking chamber
12: insulating material 13: outer enclosure
14: inner enclosure 15: bottom plate
16: control box 20: door
22: door support means 24: rotation bar
26: handle 30: cooking-material fixing means
32: cooking container 32a: handle hole
32b: bent piece 32c: heat circulation hole
34: grill 40: heater heating element
50: transparent planar heating element C: cooking material

### DETAILED DESCRIPTION

In order to fully understand the present invention, a preferred exemplary embodiment of the present invention will be described with reference to the accompanying drawings. It should be understood that the exemplary embodiment of the present invention may be changed to a variety of embodiments and the scope and spirit of the present invention are not limited to the exemplary embodiment described hereinafter. The present exemplary embodiment is provided to more completely explain the present invention to those skilled in the art. Accordingly, the shapes of elements in the drawings may be exaggerated to emphasize a clearer description. It should be noted that the same configuration in each drawing may be indicated by the same reference numeral. Detailed descriptions of known functions and configurations herein that are determined to unnecessarily obscure the subject matter of the present invention will be omitted.

Hereinafter, an exemplary embodiment of the present invention will be described in detail with reference to the accompanying drawings.

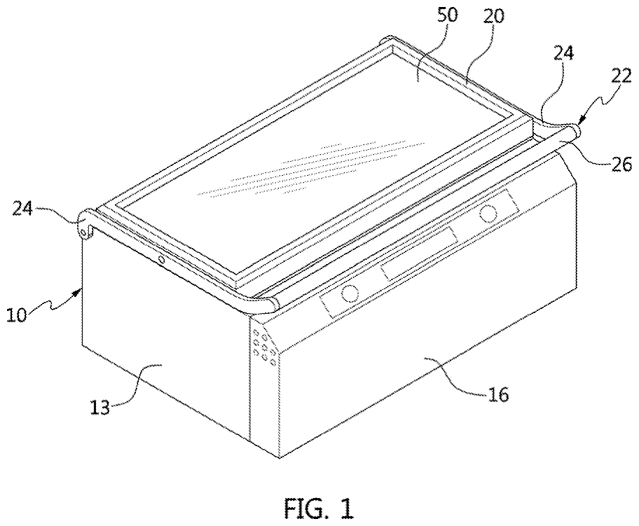

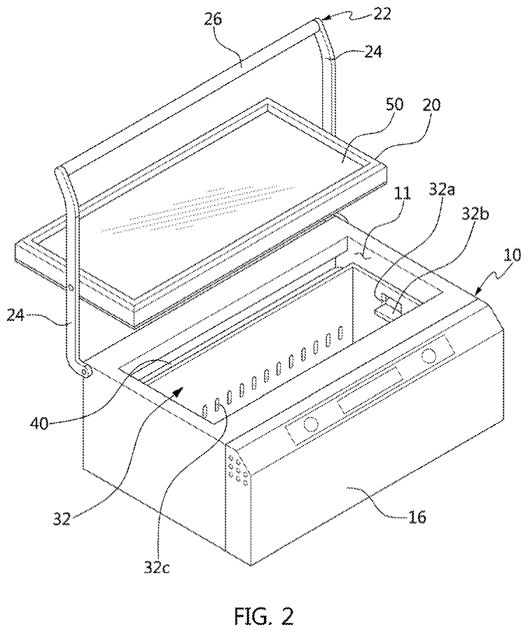

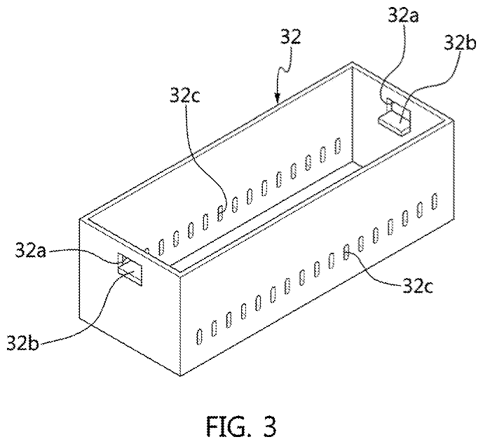

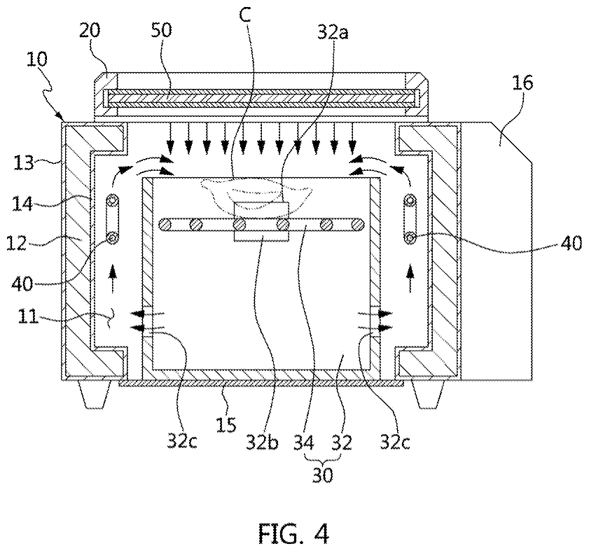

FIGS. 1 and 2 are perspective views showing a closed state and an opened state of a door of an electric composite heat oven according to the present invention, FIG. 3 is a perspective view showing a cooking container used in the electric composite heat oven according to the present invention, and FIG. 4 is a longitudinal cross-sectional view showing the electric composite heat oven according to the present invention.

Referring to FIGS. 1 to 4, in the electric composite heat oven provided with the sight window of the transparent planar heating element of the exemplary embodiment of the present invention, the electric composite heat oven includes: an enclosure 10 having a cooking chamber 11 with an open upper part thereof; a door 20 for opening and closing an opening of the enclosure 10; a cooking-material fixing means 30 for fixing a cooking material C inside the enclosure 10; a pair of heater heating elements 40 installed opposite each other on inner sidewalls of the enclosure 10 to generate convective heat at the same time; and a transparent planar heating element 50 installed in the door 20 to generate radiant heat.

That is, the enclosure 10 has a rectangular cylindrical shape, wherein the inner enclosure 14 and the outer enclosure 13 are coupled to face each other with an insulating material 12 interposed therebetween so as to form the cooking chamber 11 having the open upper opening thereof, wherein a bottom plate 15 is coupled to an outer bottom of the enclosure 10 where the inner enclosure 14 and the outer enclosure 13 contact each other, so as to close a lower opening of the enclosure 10, and a control box 16 is coupled to a front surface of the outer enclosure 13 to control the heater heating elements 40 and the transparent planar heating element 50.

The door 20 has a rectangular frame shape having an area thereof larger than an area of the upper opening of the cooking chamber 11, and the transparent planar heating element 50 is combined in an inner space of the door 20. In addition, an exterior of the door 20 is supported by a door support means 22 to open or close the upper opening of the cooking chamber 11, the door support means 22 being pivotably hinged on each side of an upper end of the enclosure 10.

In this case, the door support means 22 is configured to include: a pair of left and right rotating bars 24 having each first end thereof is pivotably hinged at the rear upper end of the left and right sides of the enclosure 10, and at the same time having each center of the left and right rotating bars 24 in the longitudinal direction is pivotably hinged with each center of the left and right sides of the door 20; and a handle 26 connecting each second end of the pair of left and right rotating bars 24.

The cooking-material fixing means 30 is configured to include: a cooking container 32 having a rectangular cylindrical shape formed lower than the height of the inner enclosure 14 so that the heat generated by each heater heating element 40 passes through the upper opening of the cooking container 32; and a grill 34 mounted on the cooking container 32.

In this case, the cooking container 32 is configured to include: bent pieces 32b protruding inward by cutting from a pair of left and right handle holes 32a so that the grill 34 is mounted horizontally at a predetermined height of the left and right sidewalls of the cooking container 32; and a plurality of heat circulation holes 32c arranged horizontally at regular intervals in each lower part of the front and rear sidewalls of the cooking container 32 so that the remaining heat after heating the cooking material C seated on the grill 34 inside the cooking container 32 is allowed to pass by the heater heating elements 40 to be circulated by natural convection.

The pair of heater heating elements 40 are formed in a U shape, and the heater heating elements 40 are respectively installed to be horizontally lain with respect to the front side wall and the rear sidewall of the cooking chamber 11 of the enclosure 10 at a predetermined height lower than the height of an upper end of the cooking container 32.

The transparent planar heating element 50 formed of a combination of glass and a planar heating element is combined by a square frame of the door 20, and while the door 20 is closed, the transparent planar heating element 50 provides a heating function for generating radiant heat in the cooking chamber 11 and a sight window function so as to allow a user to see the inside of the cooking chamber 11 at the same time.

In the electric composite heat oven provided with the sight window of the transparent planar heating element of the present invention configured as described above, since the oven has a structure in which the pair of heater heating elements 40 is installed, being lower than the upper end of the cooking container 32, on the front and rear sidewalls of the cooking chamber 11 of the enclosure 10, and the transparent planar heating element 50 is installed over the opening of the cooking chamber 11 of the enclosure 10, when operating the oven after the cooking material C is placed while the grill 34 is mounted on the bent pieces 32b inside the cooking container 32, the heater heating elements 40 and the transparent planar heating element 50 emit high-temperature convective heat and radiant heat respectively toward the cooking container 32 while generating heat at a preset temperature according to the programmed heating power control.

That is, the convective heat emitted from the pair of heater heating elements 40 flows upward by natural convection through a gap between the inner enclosure 14 and the cooking container 32 as shown in the arrow direction shown in FIG. 4, and at the same time, while flowing into the inside of the cooking container 32 through the upper opening of the cooking container 32, the convective heat merges with radiant heat to heat the cooking material C. The remaining heat after heating the cooking material C flows between the inner enclosure 14 and the cooking container 32 after passing through each of the plurality of heat circulation holes 32C formed on the lower part of the sidewall of the cooking container 32, and at the same time, is circulated to be heated again while passing by the heater heating elements 40.

Since such a composite heat oven method using convective heat of the heater heating elements 40 and the radiant heat of the transparent planar heating element 50 enables control of the intensity of convective and radiant heat during cooking, there is an advantage in that disturbances may be actively controlled, so as not to be constrained by a change in temperature depending on a place where the oven is installed.

That is, since the transparent planar heating element 50 has a structure in which glass and the planar heating element are combined with each other so as to simultaneously provide the heating function for generating radiant heat and the sight window function for allowing the user to see the inside of the cooking chamber 11, when the glass is exposed to the outside, much of the radiant heat generated from the inside of the oven may radiate to the outside where the external temperature is lower than the inside of the oven. However, since the heat lost in such a way is supplemented by the convective heat generated by the heater heating elements 40, various disturbances generated during cooking may be actively controlled, whereby it is possible to provide optimal heat power depending on the cooking material and also shorten the cooking time.

Since the cooking container 32 is able to be moved in and out of the cooking chamber 11 through the open upper opening of the cooking chamber, meat juice or food debris flowing down from the cooking material during cooking is able to be received, whereby there is the advantage in that contamination of the interior of the enclosure may be minimized and the cooking container 32 may be cleaned by being separated from the enclosure 10, so as to maintain a clean state.

Meanwhile, the present invention is not limited to the above-described exemplary embodiment, but may be embodied with modifications and variations within the scope of the gist of the present invention. Further, the technical idea to which such modifications and variations are applied should also be regarded as falling within the scope of the following claims.

1.-5. (canceled)

6. An electric composite heat oven provided with a sight window of a transparent planar heating element, the electric composite heat oven comprising:
an enclosure having a cooking chamber;
a door for opening or closing an opening of the enclosure;
a cooking-material fixing means for fixing cooking material inside the enclosure;
heater heating elements installed on inner sidewalls of the enclosure to generate convective heat; and
the transparent planar heating element installed in the door to generate radiant heat.

7. The electric composite heat oven of claim 6, wherein the transparent planar heating element is combined in an inner space of the door, and
an exterior of the door is supported by a door support means to open or close an upper opening of the cooking chamber, the door support means being pivotably hinged on a side of an upper end of the enclosure.

8. The electric composite heat oven of claim 6, wherein the cooking-material fixing means is configured to include:
a cooking container formed lower than a height of the cooking chamber so that heat generated by the heater heating elements passes through an upper opening of the cooking container; and
a grill mounted on the cooking container.

9. The electric composite heat oven of claim 8, wherein the cooking container is configured to include:
bent pieces protruding inward so that the grill is mounted at a predetermined height of sidewalls of the cooking container; and
a plurality of heat circulation holes arranged at regular intervals in a lower part of the sidewalls of the cooking container.

10. The electric composite heat oven of claim 8, wherein the heater heating elements are respectively installed to be horizontal with respect to a front sidewall and a rear sidewall of the cooking chamber at a predetermined height lower than a height of an upper end of the cooking container.
